(19) United States
(12) Patent Application Publication
(10) Pub. No.: US 2008/0130171 A1
(43) Pub. Date: Jun. 5, 2008

(54) CALCIUM ALUMINOSILICATE GLASSES FOR USE AS INFORMATION RECORDING MEDIUM SUBSTRATES

(76) Inventors: Francis Martin Behan, Corning, NY (US); Linda Ruth Pinckney, Corning, NY (US)

Correspondence Address: CORNING INCORPORATED, SP-TI-3-1, CORNING, NY, 14831, US

(21) Appl. No.: 11/606,767

(22) Filed: Nov. 30, 2006

(51) Int. Cl. G11B 5/74; C03C 3/091

(52) U.S. Cl. 360/131; 501/66

(57) ABSTRACT

A glass substrate, and a information recording medium comprised of a glass substrate, comprising an a alkali-containing calcium aluminosilicate glass comprising SiO₂, Al₂O₃, CaO, and alkali oxides (Li₂O+Na₂O+K₂O) as essential components, specifically comprising the following components, expressed in terms of mole percent (mol %): 55-70% SiO₂, 4-15% Al₂O₃, 0-8% B₂O₃, 8-20% CaO, 3-12% Na₂O+K₂O+Li₂O, 0-5% MgO, up to 5% BaO and 13-35% MgO+CaO+BaO.

### BACKGROUND OF THE INVENTION

1. Field of the Invention

The present invention relates to alkali-containing calcium aluminosilicate glass substrate for an information recording medium such as a hard disk or magnetic recording type hard disk in particular. Furthermore, the present invention relates to a method for making such glass, a glass substrate, and to an information recording medium employing the same.

2. Related Background Art

Conventionally, magnetic disks for use in stationary devices such as desk-top computers and servers typically consist of a substrate that is used to support a series of layers of uniform magnetic material. This uniform magnetic material is deposited in a sputtering process which is ultimately used to store the magnetic data. This substrate is packaged in a device containing a motor for driving the disk and a magnetic read/write head. Data are written using a magnetic head which flies over the surfaces of the magnetic layers. The data are read using the same head technology from the layers of magnetic material on the surfaces of the disk; specifically two heads are used to read/write data on both sides of the substrate

Typically, the aforementioned substrate material is comprised of either aluminum or glass. The difference in the selection of either aluminum or glass is based on the size of the magnetic disk and the rotational speed of the magnetic disk, as well whether the intended application is for either for stationary or portable devices.

Aluminum alloy is typically used for those magnetic disks for use in stationary devices such as desk-top computers and servers, and more particularly for those devices requiring 3.5″ size disks and capable of running at speeds of up to 5000 rpm. Aluminum alloy however is prone to deformation, and is not hard enough to offer satisfactory surface smoothness on the surfaces of a substrate after polishing. Moreover, when a head makes mechanical contact with a magnetic disk, the magnetic film is liable to exfoliate from the substrate. For these reasons, substrates made of glass, which offer satisfactory surface smoothness and high mechanical strength, are expected to be increasingly used in the future not only in portable devices but also in stationary devices and other home-use information devices.

Glass and glass-ceramic substrates are typically used in those portable device applications such as notebook computers and mobile computers. Specifically, glass is used for those portable devices requiring 2.5″ and smaller disk sizes and for those devices running at disk/rotational speeds of 5000 rpm or less.

One known type of glass substrate is those made of chemically strengthened glass, in which the alkali elements present near the surface of the substrate are replaced with other alkali elements in order to produce compression strain and thereby increase mechanical strength. However, chemically strengthened glass requires a complicated ion exchange process, and does not permit reprocessing once ion exchange is complete. This makes it difficult to achieve a high yield rate.

Recently, given the increase demand for consumer electronics, particularly driven by increased demand for such portable applications such as cell phones, I-pods, and portable game devices, the demand for glass substrates has, in turn, increased. Although commercial glass substrate materials such as the aforementioned chemically-strengthened glass and glass-ceramic materials, exhibit the necessary surface smoothness and inside diameter (I.D.) strength characteristics making them suitable for the 2.5″ and smaller portable applications, they are expensive to manufacture.

Given the reduced rotational speeds/forces which are seen in portable electronic device applications, particularly for those information recording disk sizes of 2.5″, 1.8″ and below, non-chemically strengthened glasses and non-glass ceramic materials are likely to be suitable materials. It is expected that such non-strengthened glasses can meet the substrate packaging requirements currently required for use in chemically strengthened glass and glass-ceramics; particularly those glass support parameters such as a high coefficient of thermal expansion (˜70×10−7/° C. or higher), a high Young's modulus (≧70 GPa) and low density (˜2.50 g/cm3).

One type of non-chemical strengthened glass substrate, are those glasses made of soda lime material. However, soda lime is not mechanically strong or chemically durable enough to be suitable as a material for substrates for information recording. Glass materials used as substrates for liquid crystal panels or the like are so prepared as to have a low or no alkali content so that they have low linear thermal expansion coefficients. This helps maintain thermal stability at high temperatures. However, as a result, these materials have linear thermal expansion coefficients that greatly differ from that of, for example, stainless steel, of which clamps and spindle motor components are made. This often causes trouble when a recording medium is mounted in a recording device or when information is recorded. Moreover, these materials are not mechanically strong enough to be suitable as a material for substrates for information recording.

It would be highly desirable and advantageous to provide for a glass material for a substrate and a glass substrate that exhibits high mechanical strength without the added expense and difficulty of ion-exchange/chemical strengthening processing, and which exhibits a linear thermal expansion which is close to that of the metal materials used in information recording medium. In particular, it would be desirable to provide a non-chemically strengthened, non-ion-exchanged, non glass-ceramic material which exhibits the requisite coefficient of thermal expansion, mechanical strength and density properties making them suitable for use as an information recording medium substrates.

### SUMMARY OF THE INVENTION

One aspect of the invention is directed at the use of calcium aluminosilicate-based glasses as low-density, moderately high modulus disk substrates for magnetic media. Furthermore, these glasses contain alkali oxides which result in high expansion glasses which are relatively easy to polish.

The advantages of these materials are their low density, moderately high modulus, high thermal expansion, and capability of yielding a polished surface with average roughness of less than 1 nm with conventional finishing processes. All of these properties are critically needed or highly desired for the application of hard disk substrates, particularly those that are not chemically-strengthened. The glasses require no unusual or expensive batch materials, are compatible with conventional tank melting, are compatible with a range of forming processes, and are compatible with conventional finishing processes.

One aspect of this present invention provides for a glass substrate, and a information recording medium comprised of a glass substrate, comprising an alkali-containing calcium aluminosilicate glass comprising SiO₂, Al₂O₃, CaO, and alkali oxides (Li₂O+Na₂O+K₂O) as essential components.

Another aspect of this present invention disclosed herein is a glass substrate, and a information recording medium comprised of a glass substrate, comprising the following components, expressed in terms of mole percent (mol %): 55-70% SiO₂, 4-15% Al₂O₃, 8-20% CaO, 3-12% Na₂O+K₂O+Li₂O, 0-5% MgO, up to 5% BaO and 13-35% MgO+CaO+BaO.

Yet another aspect of this present invention provides for a glass substrate, and a information recording medium comprised of a glass substrate, comprising an alkali-containing calcium aluminosilicate glass which exhibits a coefficient of thermal expansion (25°-300° C.) above 60×10⁻⁷/° C., preferably above 70×10⁻⁷/° C., a Young's modulus which exceeds 70 GPa, and a density less than or equal to 2.75 g/cm³, preferably less than or equal to 2.65 g/cm³.

Additional features and advantages of the invention will be set forth in the detailed description which follows, and in part will be readily apparent to those skilled in the art from that description or recognized by practicing the invention as described herein, including the detailed description and the claims which follow.

It is to be understood that both the foregoing general description and the following detailed description present embodiments of the invention, and are intended to provide an overview or framework for understanding the nature and character of the invention as it is claimed.

### DETAILED DESCRIPTION OF THE INVENTION

The present invention relates to a glass substrate for an information recording medium, a process for producing the glass substrate, and an information recording medium using the glass substrate. These will be consecutively explained hereinafter.

I. Glass Substrate for Information Recording Medium

The glass substrate for an information recording medium, provided by the present invention (to be sometimes referred to as “glass substrate of the present invention” hereinafter), is provided as a glass substrate for an information recording medium including a magnetic recording medium such as a hard disk, a magneto-optical disk and an optical recording medium such as an optical disk.

[Glass Components and Composition]

First, glass components and a glass composition for constituting the glass substrate of the present invention will be explained below. Any content of each component and any total content of a plurality of components expressed by % hereinafter represent a content or a total content by mol % unless otherwise specified.

The glass substrate of the present invention is formed of a alkali-containing calcium aluminosilicate (CAS) glass comprising SiO₂, Al₂O₃, CaO, and alkali oxides (Li₂O+Na₂O+K₂O) as essential components and comprising, by mol %, the following:

| | |
|---|---|
| SiO₂ | 55–70 |
| Al₂O₃ | 4–15 |
| CaO | 8–20 |
| Na₂O | 0–6 |
| K₂O | 0–7 |
| Li₂O | 0–4 |
| Na₂O + K₂O + Li₂O | 3–12 |
| MgO | 0–5 |
| BaO | 0–5 |
| MgO + CaO + BaO | 13–35 |
| B₂O₃ | 0–8 |
| ZrO₂ | 0–3 |

In another embodiment glass substrate comprises a glass including the following components, in mol %, 58 to 68% of SiO₂, 5 to 13% of Al₂O₃, 2-6% B₂O₃, 10 to 18% of CaO, 1 to 4% of MgO, 0-5% BaO, provided that the content of CaO+BaO+MgO at least 15% but not more than 30%, 0 to 5% Na₂O, 0-6% K₂O, 0-3% Li₂O, provided that the content of Li₂O+Na₂O+K₂O is at least 3 but not more than 10%, and 0-1.5% of ZrO₂,

In still yet another embodiment the combination of Li₂O+Na₂O+K₂O content is at least 4 but not more than 9%.

The inventive alkali-containing CAS-based glasses offer the advantage of attaining higher expansion without compromising density. Furthermore, the inclusion of the alkali oxide components (Na₂O+K₂O+Li₂O ) also enhances the finishing process, as glass substrates comprised of the inventive composition are more amenable to standard ceria polishing processes; this is thought to be due to the fact that alkali-oxygen bonds are weaker than alkaline earth-oxygen bonds, and so are more readily dissociated during the aqueous polishing process.

SiO₂ is a main component for forming a glass network structure and is an essential component that contributes to an improvement in stability of the glass, an increase in glass transition temperature and an improvement in chemical durability. When the content of SiO₂ is too small, the glass is impaired in the above properties, so that it is required to introduce 55% or more of SiO₂, and it is preferred to introduce 58% or more of SiO₂. When the content of SiO₂ is too large, the glass is degraded in Young's modulus and melting ease, and furthermore, higher silica amounts reduces the thermal expansion to unacceptable levels, so that the content of SiO₂ is limited to 70% or less, preferably, to 68% or less.

Al₂O₃ is an essential component that contributes to an increase in glass transition temperature, an improvement in durability, stabilization of a glass structure and an improvement in rigidity. For producing the above effects, Al₂O₃ is introduced so that the content thereof is 4% or more, preferably, 10% or more. When Al₂O₃ is introduced to excess, the glass is degraded in ease of melting, so that the content of Al₂O₃ is limited to 15% or less, preferably, to 13% or less.

B₂O₃ is a non-essential, but preferred, component that contributes to enhanced melting, forming, and finishing, to an increase in glass transition temperature, reduction in the density, an improvement in durability, stabilization of the glass structure and an improvement in rigidity. For producing the above effects, when B₂O₃ is introduced it should be so that the content thereof is 2% or more. When B₂O₃ is introduced to excess, the durability is likely to be decreased so that the content of B₂O₃ is limited to 6% or less.

CaO is an essential component that contributes to an improvement in ease of melting and contributes to achieving the low density characteristic. For producing the above effects, CaO is introduced so that the content thereof is 8% or more, preferably, 10% or more. When CaO is introduced to excess, however, the glass is degraded in stability, so that the content of CaO is limited to 20% or less, preferably, to 18% or less.

MgO is a an optional, but preferred component that contributes to improvements in ease of melting, Young's modulus, and to achieving the low density characteristic. For producing the above effects, MgO when introduced should be in an amount so that the content thereof is more than 1%, and preferably, 1.9% or more. When MgO is introduced to excess, however, the glass is degraded in workability (harder to melt) so that the content thereof is limited to 5% or less, preferably, to 4% or less.

BaO is an optional component that contributes to an increase in thermal expansion coefficient. When BaO is introduced to excess, the glass is degraded in durability and stability, so that the content of BaO is limited to 0 to 5%, preferably, to 0 to 3.5%. Furthermore, it will be should be noted that the addition of BaO to the glass will significantly increase the glass density; therefore, this BaO component should be kept to a minimum.

Alkaline earth metal oxides including CaO, MgO, and BaO work to contribute to an improvement in glass melting ease and an increase in thermal expansion coefficient, though not as significantly as alkali metal oxides. Therefore, the total content of the alkaline earth metal oxides including MgO and BaO as optional components, i.e., the total content of CaO, BaO, and MgO is adjusted to more than 13%, and preferably, to 15% or more. When they are introduced to excess, the glass may be fragile, so that the above total content is limited to less than 35%, and preferably, to 30% or less.

Of the above alkaline earth metal oxides, CaO is alone are essential components, and MgO and BaO are optional components. The reason therefore is as follows. Of the alkaline earth metal oxides, CaO improves the glass in devitrification resistance and also provides a reasonably high CTE. Furthermore, while the MgO also contributes to ease of melting, it tends to decrease the thermal expansion coefficient as compared with any other alkaline earth metal oxide, thus so that CaO is more preferred than MgO.

The inclusion of alkali metal oxides R₂O (Na₂O+K₂O+Li₂O) Li₂O is a necessary component that contributes to an improvement in ease of melting and finishing of the glass and an increase in thermal expansion coefficient. The total content of the R₂O, none of the individual Na₂O, K₂O, Li₂O individual components being individually required, should be such that the combination more than 3%, and preferably, to 4% or more. Excess alkali may lead to a negative impact on the glass durability. Additionally, it is important not to include excess alkali so as to minimize potential humidity deterioration of the coated information/magnetic media parts. That being said, the above total content should be limited to less than 12%, and preferably, to 10% or less. In short, the alkali amount included in the glass should empirically be determined to be an amount sufficient to achieve requisite thermal expansion and low density characteristics (above 60×10⁻⁷/° C. and below 2.75 g/cm³, respectively), but not so much as to result in potential humidity deterioration of the so-formed information/magnetic media.

For obtaining the above effect, Li₂O may be introduced, however when Li₂O is introduced to excess, the glass transition temperature is greatly decreased, so that the content thereof is limited to 4% or less.

For obtaining the above effect, Na₂O may be introduced, however, when Na₂O is introduced to excess, negative effects include decrease in the glass transition temperature and chemical durability. The content of Na₂O is therefore limited to 6% or less.

For obtaining the above effects, K₂O may be included, however when K₂O is introduced to excess, however, the glass transition temperature is potentially decreased. The content of K₂O is therefore limited to 7%.

SrO, which achieves a slight thermal expansion increase, can be added as an optional component, however too much may lead to an undesired increase in density; thus the amount added should be less than 4%.

ZrO₂ although contributes to an undesired increase in density, it can is capable of improving the chemical durability and Young modulus of the glass, however too much increase the melting temperature and density; thus the amount added should be less than 4%.

Rare earth oxides may be introduced in small quantities for improving the glass in heat resistance, durability and modulus. The total content of the rare earth oxides is adjusted to 0 to 5%, more preferably, to 0 to 3%. Since, however, the rare earth metal oxides increase the density the glass and are expensive, it is not necessary to include any one of them. Examples of the possible rare earth oxides which can be included include Y₂O₃, La₂O₃, Gd₂O₃, Yb₂O₃, Pr₂O₃, Sc₂O₃, Sm₂O₃, Tb₂O₃, Dy₂O₃, Nd₂O₃, Eu₂O₃, Ho₂O₃, Er₂O₃, Tm₂O₃, and Lu₂O₃. When a rare earth oxide is introduced, it is preferred to introduce Y₂O₃, since an increase in the specific gravity of the glass is relatively small and since the Young's modulus is highly effectively increased.

Low levels of transition metal oxides and fining agents, may also be included such as As₂O₃ or Sb₂O₃. Titania is not recommended as it tends to promote phase separation in CAS-based glasses.

In the glass composition for the glass substrate of the present invention, preferably, the total content of SiO₂, Al₂O₃, MgO+CaO+BaO, Li₂O+Na₂O+K₂O and optional components such as B₂O₃, ZrO2 and SrO is more than 95%, more preferably, the above total content is 99%, still more preferably, the above total content is 100%.

The above glass for constituting the glass substrate of the present invention can be obtained by heating and melting a glass raw material according to a known high-temperature melting method, refining and homogenizing a molten glass and cooling the molten glass; more detailed explanation provided in subsequent portions of the application.

[Properties of Glass and Glass Substrate]

Properties of the glass for constituting the glass substrate of the present invention and properties of the glass substrate of the present invention will be explained below.

The glass constituting the glass substrate of the present invention preferably has a large thermal expansion coefficient so that its thermal expansion property matches the thermal expansion property of a clamp material used for fixing the central portion of the substrate in an information recording device. Hence, when it is bonded or joined to a metal, for example, the strain, displacement, or crack breakage of the glass resulting from the difference in the thermal expansion coefficient therebetween can be prevented from occurring. Generally, the clamp is made of stainless steel, so that it is preferred that the average linear expansion coefficient of the glass at 25 to 300° C. should be 60×10⁻⁷/° C. or more so that the thermal expansion property of the stainless steel and the glass substrate can be matched. The above average linear expansion coefficient (25°-300° C.) is more preferably above 70×10⁻⁷/° C. Although the upper limit of the thermal expansion coefficient is not particularly limited, the practical range thereof is preferably 110×10⁻⁷/° C.

Furthermore, it should be noted that even when magnetic recording media have narrowed recording tracks, a tracking error that is caused by the difference in thermal expansion between the glass and the metal structural material can be prevented or avoided from occurring; thus reemphasizing the importance that the requirement that the glass composition of the present invention exhibit a thermal expansion coefficient that is substantially equal to that of the metal material.

The glass constituting the glass substrate of the present invention preferably has a low density which is preferably at or below 2.75 g/cm³, more preferably below 2.65 g/cm³, most preferably below 2.55 g/cm³. This low density characteristic is required so as to match the low weight of the magnetic media (substrate plus magnetic coatings), thereby enabling longer battery life.

Preferably, the glass substrate of the present invention is a material that has high Young's modulus which, in turn, enables stable high-speed rotation of an information recording medium. The Young's modulus thereof is preferably at least 70 GPa, more preferably at least 75 GPa. Additionally, it should be noted that this high Young's modulus characteristic results in optimal ease of handling and to increase the ability of the information recording medium's ability to accommodate the wear and tear associated with use in portable consumer electronics.

The glass composition of the present invention has a glass transition temperature of at least 600° C. Accordingly, the properties thereof are not deteriorated even when, for instance, the glass substrate is heated in forming a magnetic recording layer thereon by sputtering. The glass composition therefore is suitable for the substrate for perpendicular magnetic recording media that is heated at particularly high temperatures. A higher glass transition temperature allows the treatment to be conducted at higher temperatures. Accordingly, the glass transition temperature is preferably as high as possible, but with consideration given to the practical range of the glass transition temperature, it is preferably 700° C. or lower.

II. Process for Producing Glass Substrate for Information Recording Medium

A glass material and a glass substrate according to the invention are produced by any conventionally known production process, for example in the following manner. Raw materials of glass ingredients, i.e., oxides, carbonates, nitrates, hydroxides, and the like corresponding to the individual ingredients, are, in the desired proportions and in the form of powder, fully mixed to obtain a blending of the raw materials. This blending is then put, for example, in a platinum crucible placed inside an electric furnace or a refractory tank heated to 1,400 to 1,550° C., where the blending is first melted and clarified and then stirred and homogenized. The glass can thereafter be fabricated into several types of form. For example, the molten glass can be poured into a preheated mold, and cooled slowly so as to be formed into a columnar or/cylindrical glass block. Next, the columnar or cylindrical glass block can again be heated again to close to its glass transition point and then cooled slowly so as to be well annealed The glass block thus obtained is then sliced into a disks, and is cut out using a core drill so as to have concentric outer and inner edges.

The disk-shaped glass material thus obtained is then formed into a glass substrate by subjecting the two flat surfaces of the glass material to coarse and fine polishing and then to cleaning using at least one of a water liquid, an acidic liquid, or an alkaline liquid. More specifically, in the polishing of the main surface, the main surface is lapped with an abrasive or diamond pellets or polished with cerium oxide, whereby the surface accuracy thereof can be adjusted, for example, to the range of 0.1 to 0.6 nm. After the polishing, the substrate surface is preferably brought into a clean state by washing it with a wash liquid.

The thus-obtained glass substrate of the present invention has the form of a disk, and has a hole made in its center for attaching a clamp for rotating the substrate. The glass substrate of the present invention can be applied to various disks having various outer diameters such as disks having nominal diameters of 1 inch, 2.5 inches, and the like.

III. Information Recording Medium and Process for Producing the Same

The information recording medium of the present invention comprises the above glass substrate of the present invention and at least information recording layer formed thereon, and it can be applied to various information recording media such as a magnetic recording medium, a magneto-optical recording medium, an optical recording medium, etc., by selecting the information recording layer as required.

The layer constitution formed on the substrate, and the like, will be explained by referring, as example, to a magnetic disk that is a magnetic recording medium.

The magnetic disk generally has layers such as an undercoat layer, a magnetic layer, a protective layer, a lubricant layer, etc., which are consecutively formed on a glass substrate. While the magnetic layer is not specially limited, preferably, examples thereof include a Co—Cr-containing, Co—Cr—Pt-containing, Co—Ni—Cr-containing, Co—Ni—Pt-containing, Co—Ni—Cr—Pt-containing and Co—Cr—Ta-containing magnetic layers and others. The above “-containing” means that a magnetic layer contains at least substances specified.

As an undercoat layer, an Ni layer, an Ni—P layer, a Cr layer or the like can be used, and as a protective layer, a carbon film, or the like can be used. For the lubricant layer, lubricants such as a perfluoropolyether-containing lubricant, etc., can be used.

The information recording medium of the present invention can be particularly suitably applied to a perpendicular magnetic recording medium. The production of a perpendicular magnetic recording medium requires high-temperature treatment, and the glass constituting the glass substrate for an information recording medium, provided by the present invention, has a sufficiently high glass transition temperature as compared with the temperature employed for the heat treatment in the process of producing the information recording medium, so that the glass substrate is not deformed by the heat treatment. Further, the glass substrate has a high enough transition temperature so that it can be easily handled during the production step, and information recording media can be highly productively produced.

In the perpendicular magnetic recording disk, the layer constitution formed on the substrate includes a single-layered film in which a perpendicular magnetic recording layer is formed on the glass substrate that is a non-magnetic material, a bi-layered film in which a soft magnetic layer and a magnetic recording layer are consecutively stacked, a three-layered film in which a hard magnetic layer, a soft magnetic layer and a magnetic recording layer are consecutively formed, and the like. Of these, the bi-layered film and the three-layered film are preferred since they are more suitable for attaining a higher recording density and maintaining stability of a magnetic moment than the single-layered film.

### EXAMPLES

Hereinafter, the present invention is described in detail using examples. Glasses having the glass compositions shown in Examples 1 to 13 that were those of the present invention were prepared. Thereafter, with respect to the glasses thus obtained, the glass transition temperature, the thermal expansion coefficient, the density, the Young's moduli were measured. The results are shown in Table I. In addition, four alkali-free comparative examples were prepared and properties measured; these are shown in Table II as Comparative Examples 1-4.

The preparation of the glasses of Examples 1 to 12 and Comparative Examples 1 to 4 and the measurements of the properties of the resulting glasses were conducted according to the following procedures

Preparation of Glass Substrates for Magnetic Recording Media

First, using silica, alumina, lithium carbonate, sodium carbonate, potassium carbonate, basic magnesium carbonate, calcium carbonate, strontium carbonate, barium carbonate and zirconium oxide, which were common raw materials for glass, batches were prepared so as to have glass compositions shown in Tables I and II. Each of the batches thus prepared was placed in a platinum crucible and was heated and maintained in an electric furnace at 1550° C. for four hours. Thus a molten glass was obtained. This was taken out of the furnace and then was poured on an graphite sheet. This was cooled to form a glass block. This glass block was placed in the electric furnace again and was kept at 675° C. for two hours. Thereafter, the furnace was switched off to allow it to cool slowly down to room temperature. Thus, each sample glass was obtained.

Each sample glass was processed into a square block having dimensions of about 15×15 cm and thickness of between 1-2 cm. Thereafter, the thermal expansion coefficient and the glass transition temperature thereof were measured with a dilatometer. The density and Young's modulus were also measured utilizing standard measurement techniques known to those skilled in the art.

An examination of Table I reveals that all the inventive composition samples of the present invention exhibited a thermal expansion coefficient (25-300° C.) ranging between 63×10⁻⁷/° C. to 82×10⁻⁷/° C.; that is, at least 60×10⁻⁷/° C. as claimed herein and thus compatible with the thermal expansion exhibited by the metal (stainless steel) materials utilized in information recording media.

Lastly, it should be noted that the glasses of Examples 1 to 12 of the present invention all exhibit a density of less than 2.74 g/cm³; with all but 2 inventive composition samples having a density of less than 2.55 g/cm³. Accordingly each of the inventive composition samples exhibits a low density characteristic sufficient to match the low weight of the information recording/magnetic media.

On the other hand, the glass of Comparative Example 1-4 each exhibits a coefficient of thermal expansion (25-300° C.) of 58×10⁻⁷ or less; in part due to the alkali-free nature of these glasses. Although comparison samples exhibit the requisite low density characteristic, the low thermal expansion is not sufficient to match that of the metal (stainless steel) typically utilized in information/magnetic recording media and thus these glasses would not be suitable for use as information/magnetic recording media substrates. It should be noted that these glasses were specifically developed for use as LCD panels, manufactured via the fusion-drawing process, and thus the requirement that the glasses be designed to exhibit high use temperatures (strain points) and have thermal expansions well under 60×10⁷/° C., so that they would be compatible with the silicon thin film transistors utilized in display devices.

TABLE I

| | Ex. 1 | Ex. 2 | Ex. 3 | Ex. 4 | Ex. 5 | Ex. 6 | Ex. 7 | Ex. 8 | Ex. 9 | Ex. 10 | Ex. 11 | Ex. 12 |
|---|---|---|---|---|---|---|---|---|---|---|---|---|
| SiO₂ | 66.0 | 64.7 | 61.3 | 63.0 | 62.5 | 63.0 | 64.0 | 63.0 | 61.0 | 63.0 | 62.0 | 67.0 |
| Al₂O₃ | 6.3 | 7.0 | 7.0 | 10.0 | 10.0 | 9.0 | 10.0 | 10.0 | 12.0 | 11.0 | 9.0 | 6.0 |
| B₂O₃ | 2.7 | 2.5 | 2.5 | 2.5 | 3.5 | 5.0 | 3.5 | 2.5 | 6.0 | 6.0 | 6.0 | 6.0 |
| CaO | 17.1 | 16.0 | 16.0 | 16.0 | 15.0 | 14.0 | 13.5 | 14.0 | 11.5 | 14.0 | 12.0 | 10.0 |
| MgO | 3.2 | 3.2 | 3.2 | 3.5 | 3.0 | 3.0 | 3.0 | 3.5 | 3.5 | 2.0 | 2.0 | 4.0 |
| BaO | | 2.0 | 4.0 | | | | | | | | | |
| Na₂O | 2.0 | 2.0 | 3.0 | 2.0 | 3.0 | 3.0 | 3.0 | 3.0 | 3.0 | 3.0 | 4.5 | 4.5 |
| K₂O | 2.7 | 2.6 | 3.0 | 2.0 | 3.0 | 3.0 | 2.0 | 3.0 | 3.0 | 1.0 | 4.5 | 4.5 |
| Li₂O | | | | | | | 1.0 | | | | | |
| ZrO₂ | | | | | | | | 1.0 | | | | |
| Density (g/cm³) | 2.52 | 2.64 | 2.74 | 2.57 | 2.516 | 2.497 | 2.505 | 2.546 | 2.481 | 2.490 | 2.484 | 2.414 |
| CTE (25–300 C.) × 10⁻⁷/C. | 69 | 72 | 79 | 66 | 68 | 69 | 63 | 66.5 | | | | |
| Young's modulus | 75 | 87 | 88 | 90 | 81 | 77 | 83 | 82 | | | | |
| GPa | | | | | | | | | | | | |
| Transition | 686 | | | 689 | | | | | | | | |
| Temperature/Strain | | | | | | | | | | | | |
| Point (° C.) | | | | | | | | | | | | |

TABLE II

| | Comparative | Comparative | Comparative | Comparative |
|---|---|---|---|---|
| | Ex. 1 | Ex. 2 | Ex. 3 | Ex. 4 |
| SiO₂ | 66.0 | 66.0 | 69.5 | 59.0 |
| Al₂O₃ | 9.9 | 10.0 | | 9.2 |
| B₂O₃ | 4.1 | 4.7 | 9.7 | 4.5 |
| CaO | 14.0 | 13.6 | 9.1 | 22.3 |
| MgO | | | 0.1 | 4.6 |
| SrO | 1.0 | 0.1 | 0.5 | |
| BaO | 4.4 | 5.6 | | |
| Na₂O | 0 | 0 | 0 | 0 |
| K₂O | 0 | 0 | 0 | 0 |
| Li₂O | 0 | 0 | 0 | 0 |
| ZrO₂ | | | | |
| Density | 2.7 | 2.7 | ~2.5 | 2.63 |
| CTE | 49 | 49 | ~32 | 58 |
| (25–300 C.) × | | | | |
| 10⁻⁷/C. | | | | |
| Young's | | | ~72 | |
| modulus GPa | | | | |

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A glass substrate for an information recording medium, which is formed of a glass comprising SiO₂, Al₂O₃, CaO, and B₂O₃ as essential components and comprising, in mol %, 55 to 70% of SiO₂, 4 to 15% of Al₂O₃, 0-8% B₂O₃, 8 to 20% of CaO, 0 to 5% of MgO, 0-5% BaO, provided that the content of CaO+BaO+MgO at least 13% but not more than 35%, 0 to 6% Na₂O, 0-7% K₂O, 0-4% Li₂O, provided that the content of Li₂O+Na₂O+K₂O is at least 3 but not more than 12%.

2. The glass substrate for an information recording medium as claimed in claim 1, comprising, in mol %, 58 to 68% of SiO₂, 5 to 15% of Al₂O₃, 10 to 18% of CaO, 2-6% B₂O₃, 1 to 4% of MgO, provided that the content of CaO+BaO+MgO at least 15% but not more than 30%, and the Li₂O+Na₂O+K₂O content is at least 3 but not more than 10%.

3. The glass substrate for an information recording medium as claimed in claim 1, wherein the Li₂O+Na₂O+K₂O content is at least 4 but not more than 9%.

4. The glass substrate for an information recording medium as claimed in claim 1, wherein the glass has a coefficient of thermal expansion (25°-300° C.) above 60×10⁻⁷/° C.

5. The glass substrate for an information recording medium as claimed in claim 1, wherein the glass has a coefficient of thermal expansion (25°-300° C.) above 70×10⁻⁷/° C.

6. The glass substrate for an information recording medium as claimed in claim 1 where the glass has a Young's modulus between 70-100 GPa.

7. The glass substrate for an information recording medium as claimed in claim 1 where the glass has density less than or equal to 2.75 g/cm³.

8. The glass substrate for an information recording medium as claimed in claim 1 where the glass has density less than or equal to 2.65 g/cm³.

9. The glass substrate for an information recording medium as claimed in claim 1 where the glass has density less than or equal to 2.55 g/cm³

10. An information recording medium comprising:
a glass substrate; and
a magnetic film formed on top of the glass substrate directly or with one or more intermediate layers interposed in between
wherein the glass substrate is comprised of the following components, in mol %, comprises 55 to 70% of SiO₂, 4 to 15% of Al₂O₃, 0-8% B₂O₃, 8 to 20% of CaO, 0 to 5% of MgO, 0-5% BaO, provided that the content of CaO+BaO+MgO at least 13% but not more than 35%, 0 to 6% Na₂O, 0-7% K₂0, 0-4% Li₂O, provided that the content of Li₂O+Na₂O+K₂O is at least 3 but not more than 12%.

11. The information recording medium as claimed in claim 10, wherein the glass substrate is comprised of, in mol %, 58 to 68% of SiO₂, 5 to 15% of Al₂O₃, 10 to 18% of CaO, 2-6% B₂O₃, 1 to 4% of MgO, provided that the content of CaO+BaO+MgO at least 15% but not more than 30%, and the Li₂O+Na₂O+K₂O content is at least 3 but not more than 10%.

12. The information recording medium as claimed in claim 10, wherein the Li₂O+Na₂O+K₂O content is at least 4 but not more than 9%.

13. The information recording medium as claimed in claim 10 exhibiting the following properties: a the glass has a coefficient of thermal expansion (25°-300° C.) above 60×10⁻⁷/° C., a Young's modulus between 70-100 GPa, and a density of less than or equal to 2.75 g/cm³.

14. The information recording medium as claimed in claim 13 where the glass substrate has density less than or equal to 2.65 g/cm³.

15. The information recording medium as claimed in claim 13 where the glass substrate has a coefficient of thermal expansion (25°-300° C.) above 70×10⁻⁷/° C.
